(19) United States
(12) Patent Application Publication
(10) Pub. No.: US 2011/0292777 A1
(43) Pub. Date: Dec. 1, 2011

(54) METHOD FOR CALIBRATING TRACKING ERROR SIGNAL IN OPTICAL DISK DRIVE

(76) Inventor: Yi-Long Hsiao, Taoyuan County (TW)

(21) Appl. No.: 13/104,985

(22) Filed: May 11, 2011

(30) Foreign Application Priority Data
May 25, 2010 (TW) 099116916

(51) Int. Cl. G11B 7/09

(52) U.S. Cl. 369/44.25; 369/44.35; G9B/7.066

(57) ABSTRACT

A method is provided to start calibrating TE signals in an optical disk drive by checking the change of focus balance, outputting a first TE signal by adjust to a predetermined gain, measuring the peak and trough of the first TE signal, changing the laser power to output a second TE signal on condition of the same focus balance and predetermined, measuring the peak and trough of the second TE signal, calculating and adjusting to a calibrated gain to quickly calibrate the TE signal.

### BACKGROUND OF THE INVENTION

1. Field of the Invention

The invention relates to an optical disk drive for reading an optical disk, and more particularly, to a method for calibrating tracking error (TE) signals in an optical disk drive by adjusting a gain.

2. Description of the Prior Art

Focusing error (FE) signals and tracking error (TE) signals generated by an optical disk drive projecting small light points to focus on an optical disk and receiving reflecting light flux of the optical disk, control the light points to maintain focusing on the optical disk and moving along data tracks, so as to read and write data on the optical disk precisely.

As shown in FIG. 1, FIG. 1 shows a diagram of a conventional optical disk drive calibrating TE signals. The conventional optical disk drive 10 utilizes an optical pickup head 11 to project light beam emitted from a laser photodiode 12 and focus it on a rotating optical disc 13, and the optical disk 13 reflects it back to the optical pickup head 11 and project it on an optical transducer 14 to form a reflecting light point 15. Sub-units A, B, C, D are equally divided from the optical transducer 14, and form a left half unit (A+D) and a right half unit (B+C), which receive light flux of the reflecting light point 15 and transform it to corresponding electrical signals, respectively. Zero crossing TE signals are formed by signal difference of (A+D)−(B+C), and the light beam is controlled to read and write data on the optical disk 13 along data tracks 16 with a goal of making TE signals equal to 0.

Since differences exist in optical system and signal circuit of the optical disk drive 10, even the light beam projected by the optical pickup head 11 is adjusted to focus on the optical disk 13 and focus balance is achieved, the circular reflecting light point 15 reflected on the optical transducer 14 does not necessarily fall in the central part of the optical transducer 14. As a result, the light fluxes of the left half unit (A+D) and the right half unit (B+C) of the optical transducer 14 are not equal to each other, that is, an up amplitude M and a down amplitude N of the TE signal are asymmetric. Thus, the optical disk drive is required to calibrate a gain K before sent out from factory. A gain device 17 is utilized to make K=M/N, and to make the up amplitude M and the down amplitude N of the TE signal symmetric for good zero crossing servo control, so as to prevent the projected light beam of the optical pickup head 11 from having offset from data tracks.

However, a basis reference F of the TE signal is unknown, and the up amplitude M and the down amplitude N of the TE signal can not be measured directly to get an optimal gain K, and it cost a lot of time for the optical disk drive to calibrate the gain K. Moreover, to fit the requirements of reading and writing effects of the optical disk drive, the optical pickup head 11 moves focus of the light beam to the optical disc 13, to make shape of the reflecting light point 15 projected by a stigmatism in the optical transducer 14 becomes a reflecting light point 18, and focus balance is changed, so that the light fluxes of the sub-units A, B, C, D receiving the reflecting light change. If the original gain K is utilized continuously, control of the TE′ signal will be abnormal, and make the light point projected by the the optical pickup head 11 have offset from the data tracks. Especially during writing process of increasing most laser power, it is possible to make the servo system extremely unstable, to be biased from writing positions and generate writing failures. It is necessary to cost a lot of time for finding another gain. Thus, there are still problems to be solve for the TE signal calibration of the conventional optical disk drive.

### SUMMARY OF THE INVENTION

One objective of the present invention is to provide a method for calibrating tracking error (TE) signals in an optical disk drive, which can quickly get a calibrated gain for the TE signals via simple calculation by measuring peaks and troughs of the TE signals before and after changing laser power.

Another objective of the present invention is to provide a method for calibrating TE signals in an optical disk drive, which can quickly re-calibrate the gain of the TE signals after focus balance of the optical disk drive is changed, to ensure correctness and stability of tracking servo when reading and writing.

To achieve the abovementioned objectives, the method for calibrating TE signals in an optical disk drive of the present invention comprises: checking the change of focus balance as timing of starting the TE signal calibration, and outputs a first TE signal by adjusting a gain to a predetermined gain; measuring a peak P1 and a trough G1 of the first TE signal; changing a laser power to output a second TE signal under a condition of a same focus balance and the same predetermined gain; measuring a peak P2 and a trough G2 of the second TE signal; calculating a calibrated gain=(P2−P1)/(G1−G2); and adjusting the gain to be the calibrated gain.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a diagram of a conventional optical disk drive calibrating TE signals.

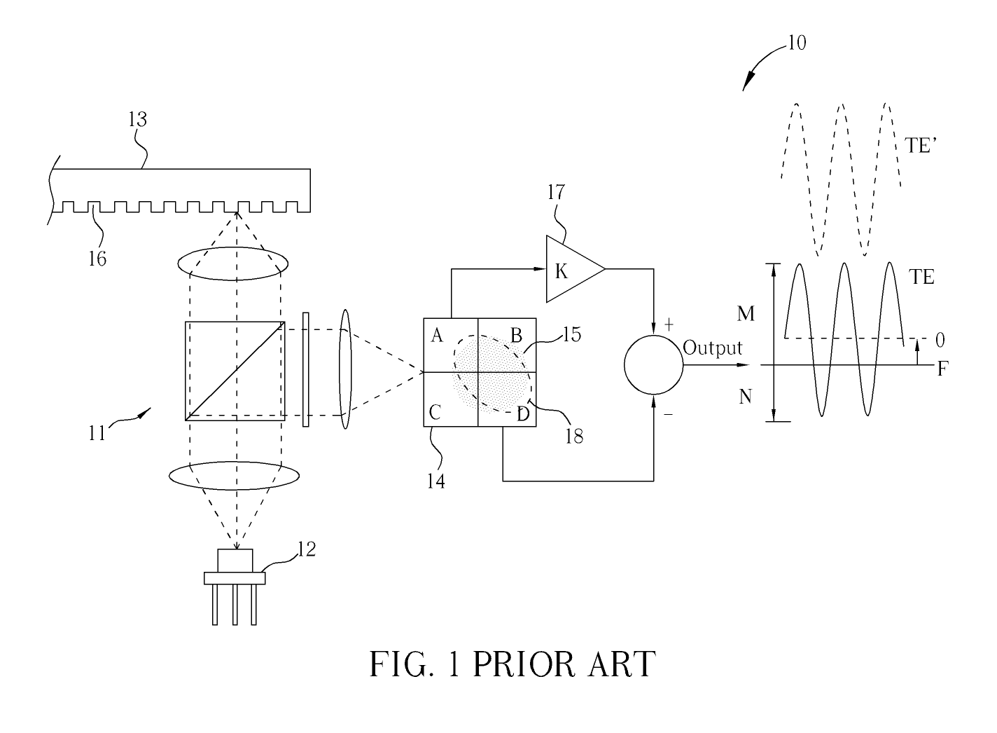

FIG. 2 shows a diagram of a method for calibrating tracking error (TE) signals in an optical disk drive of the present invention.

FIG. 3 is a diagram of the optical disk drive outputting a TE signal after changing the laser power.

FIG. 4 is a diagram of calculating a calibrated gain Kb of the TE signal.

FIG. 5 is a method for calibrating TE signals in an optical disk drive of the present invention.

FIG. 6 is a diagram of calculating TE signals of changing focus balance of an optical disk drive of the present invention.

### DETAILED DESCRIPTION

In order to achieve the abovementioned objectives of the present invention, the adopted technical means and effects are described below by illustrating embodiments with drawings.

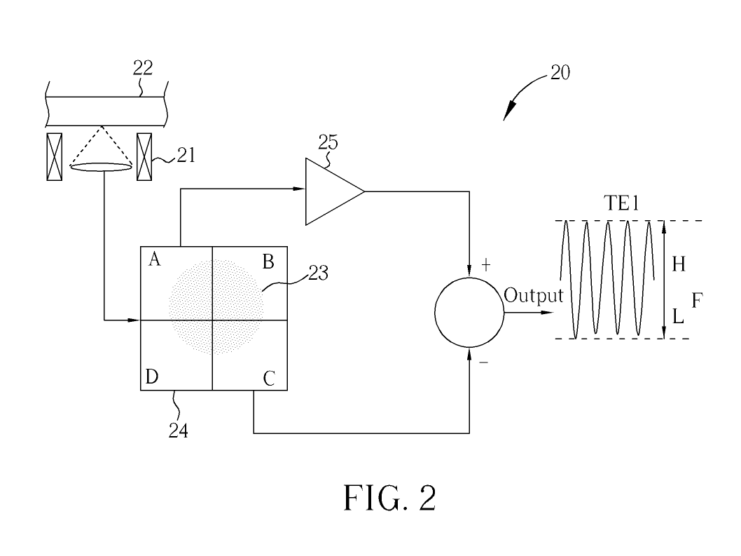

Please refer to FIG. 2 showing a diagram of a method for calibrating tracking error (TE) signals in an optical disk drive of the present invention. The optical disc drive 20 utilizes an optical pickup head 21 to move up and down to project light beam focus on an optical disc 22. After achieving focus balance, the optical disc 22 reflects the projected light beam to the optical pickup head 21 to form a reflecting light point 23 and project it to an optical transducer 24, and sub-units A, B, C, D divided from the optical transducer 24 receive it and transform it to TE signals and output the TE signals. Since a gain device 25 is not calibrated before sent out from factory, a first TE signal TE1 is adjusted by a gain Kb of a predetermined gain, and the predetermined gain can be 1 to output the first TE signal TE1. An up amplitude H and a down amplitude L of the first TE signal TE1 are asymmetric according to a reference level F. In this embodiment, the up amplitude H is greater than the down amplitude L.

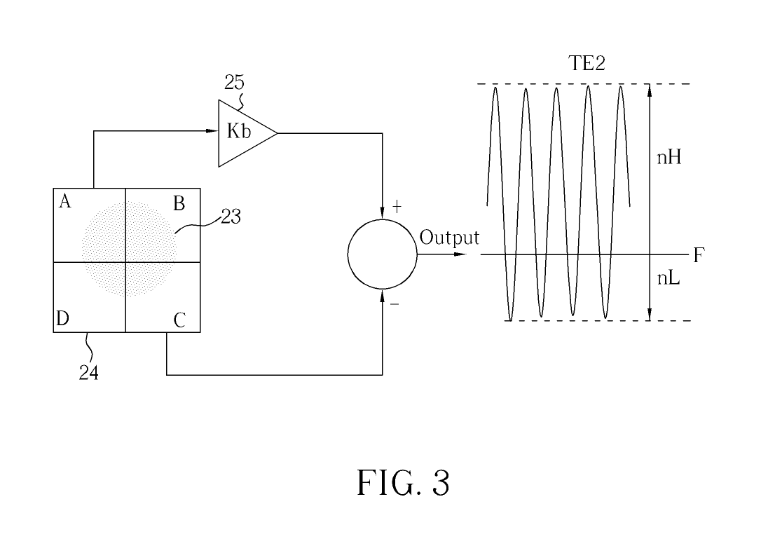

Since the reflecting light point 23 projected to the optical transducer 24 by the optical pickup head 21 is still maintained in the original position under a condition of a same focus balance, the size and shape of the reflecting light point 23 are not changed. However, light flux density of the reflecting light point 23 will change according to the laser power of the optical pickup head 21. That is, the reflecting light point 23 has a higher luminance when the optical pickup head 21 has a greater laser power, and the reflecting light point 23 has a lower luminance when the optical pickup head 21 has a smaller laser power. As shown in FIG. 3, FIG. 3 is a diagram of the optical disk drive outputting a TE signal after changing the laser power. If the optical disk drive maintains in the state of outputting the first TE signal TE1 (i.e. the predetermined gain Kb of the gain device 25 and the focus balance condition are not changed), the laser power is changed to a predetermined multiple of power, such as n multiple of power, and light flux density received by the sub-units A, B, C, D of the optical transducer 24 will increase to be n multiple accordingly, to output a second TE signal TE2. The second TE signal TE2 has asymmetric up and down amplitudes according to the reference level F, and the up and down amplitudes will increase to be n multiple respectively to be nH and nL. Since the gain Kb is not changed, the reference level F maintains as the unknown reference level F of the first TE signal TE1.

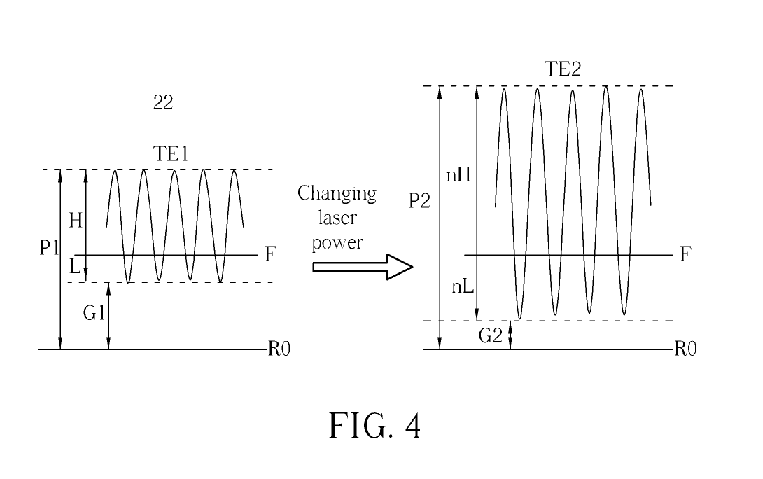

As shown in FIG. 4, FIG. 4 is a diagram of calculating a calibrated gain Kb of the TE signal. The first TE signal TE1 and the second TE signal TE2 outputted before and after changing the laser power are compared by aligning the reference level F. Next, using a relative level R0 as a reference to measure a peak P1 and a trough G1 of the first TE signal TE1 before the laser power is changed, and to measure a peak P2 and a trough G2 of the second TE signal TE2 after the laser power is changed, wherein:

P2−P1=(n−1)H (1)

G1−G2=(n−1)L (2)

Make the formula (1) divided by the formula (2) to get:

H/L=(P2−P1)/(G1−G2) (3)

According to the formula (3), a ratio of the up and down amplitude of the first TE signal TE1 can be easily obtained by measuring the peak and trough of the TE signal before changing the laser power, to get the calibrated gain Kb=H/L, to make the up and down amplitude of the TE signal be the same so that zero-crossing servo control can operate well to prevent the projected light of the optical pickup head from having offset from data tracks.

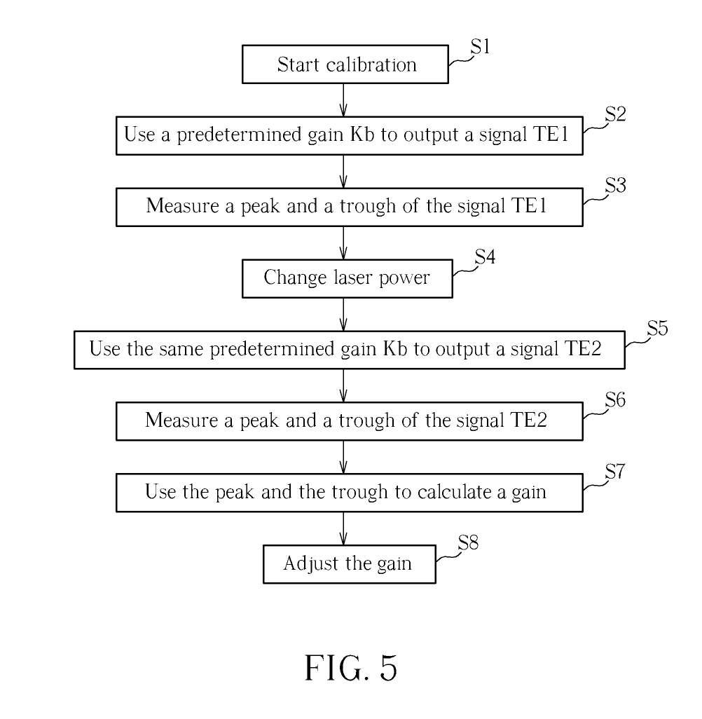

As shown in FIG. 5, FIG. 5 is a method for calibrating TE signals in an optical disk drive of the present invention. The steps of the invention measuring the peak and trough of the TE signal before changing the laser power to calculate the calibrated gain Kb are illustrated as follows. Step S1 starts to calibrate TE signals. In Step S2, the gain Kb is adjusted to a predetermined gain to output a first TE signal TE1. Step S3 uses a relative level as a reference to measure a peak P1 and a trough G1 of the first TE signal TE1 before the laser power is changed. In Step S4, under a condition of a same focus balance, the laser power is changed (for example, the laser power is changed to be n multiple of power). Step S5 uses the same predetermined gain to output a second TE signal TE2. Step S6 uses the same relative level to measure a peak P2 and a trough G2 of the second TE signal TE2 after the laser power is changed. Step S7 uses the peak P1 and the trough G1 of the first TE signal TE1, and the peak P2 and the trough G2 of the second TE signal TE2 to calculate a calibrated gain H/L=(P2−P1)/(G1−G2) with the formula (3). Step S8 adjusts the gain to be the calibrated gain to complete the calibration.

Thus, the method for calibrating TE signals in an optical disk drive of the invention can quickly get a calibrated gain for the TE signals via simple calculation by measuring peaks and troughs of the TE signals before and after changing laser power and by changing the laser power to output the TE signals on a condition of the same focus balance and predetermined gain.

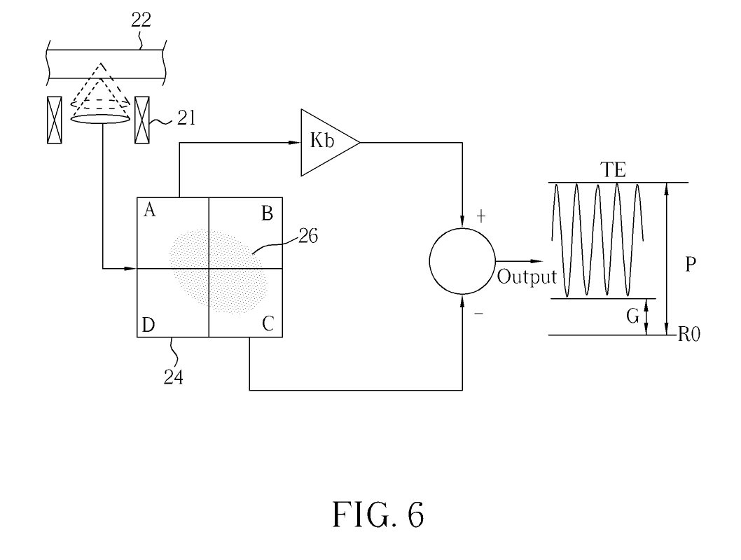

As shown in FIG. 6, FIG. 6 is a diagram of calculating TE signals of changing focus balance of an optical disk drive of the present invention. The method for calibrating TE signals in an optical disk drive of the invention can be applied to gain calibration of the optical disk drive, and can be further applied to a condition of changed focus balance for requirements of reading and writing effects of the optical disk drive. When the optical pickup head 21 moves focus of the light beam to the optical disc 22 and locks it, the focus balance is changed, and the shape of a reflecting light point 26 projected on the optical transducer 24 becomes non-circular, and the light flux density received by the sub-units A, B, C, D changes accordingly. Thus, the original calibrated gain Kb can not be used, and another gain is required to be found.

Therefore, the present invention method can check whether a focus balance is changed to determine a timing of starting to calibrate the TE signal. After the optical disk drive changes the focus balance, the present invention method also can output TE signals by changing laser power under a condition of a same focus balance and the same predetermined gain, and quickly get a calibrated gain for the TE signals again after changing the focus balance via simple calculation by measuring peaks P and troughs G of the TE signals before and after changing laser power and the peaks and troughs (P2−P1)/(G1−G2) calibrated by the formula (3) with the same relative level R0, so as to correctness and stability of tracking servo when reading and writing.

Those skilled in the art will readily observe that numerous modifications and alterations of the device and method may be made while retaining the teachings of the invention.

What is claimed is:

1. A method for calibrating tracking error (TE) signal in an optical disk drive, comprising:
(1) outputting a first TE signal by adjusting a gain to a predetermined gain;
(2) measuring a peak P1 and a trough G1 of the first TE signal;
(3) changing a laser power to output a second TE signal under a condition of a same focus balance and the same predetermined gain;
(4) measuring a peak P2 and a trough G2 of the second TE signal,
(5) calculating a calibrated gain=(P2−P1)/(G1−G2); and
(6) adjusting the gain to be the calibrated gain.

2. The method of claim 1, wherein the gain is 1.

3. The method of claim 1, wherein the first or second TE signals are measured by predetermining a relative level as a reference.

4. The method of claim 1, wherein the laser power is changed to a predetermined multiple of power.

5. The method of claim 4, wherein the laser power is changed to increase a predetermined multiple of power.

6. The method of claim 1, further comprising: checking whether a focus balance is changed to determine a timing of starting to calibrate the TE signal.
